(19) United States
(12) Patent Application Publication
(10) Pub. No.: US 2016/0153604 A1
(43) Pub. Date: Jun. 2, 2016

(54) SYSTEM AND METHOD FOR SEALING SUBMERGED OPENINGS

(71) Applicant: VIRGINIA TRANSFORMER CORPORATION, Roanoke, VA (US)

(72) Inventor: Prabhat JAIN, Roanoke, VA (US)

(73) Assignee: VIRGINIA TRANSFORMER CORPORATION, Roanoke, VA (US)

(21) Appl. No.: 14/557,779

(22) Filed: Dec. 2, 2014

(51) Int. Cl. F16L 55/18; B65D 88/78

(52) U.S. Cl. CPC F16L 55/18; B65D 88/78

(57) ABSTRACT

A system and method that may be used to seal one or more submerged openings for a piece of submerged equipment may be shown and described. The system and method can have a pump having an uninterruptable power supply and a display, the uninterruptable power supply includes a battery back-up that provides a constant source of electrical energy; a tube connection extended from the pump, the tube connection providing a pressurized media to the system; a submerged enclosure receiving the pressurized media from the tube connection extending from the pump, the submerged enclosure includes one or more internal bellows, a submerged opening and an electronic module with a differential pressure transducer; a pressure control signal emitted from the differential pressure transducer, the pressure control signal transmitted to and displayed on the display; and an internal leak protector providing an alarm output signal to the display when the pressurized media is leaking.

### BACKGROUND

It is a common practice that many enclosures often have connections and openings that are sealed with a weld. While performing regular maintenance, repairing and refurbishing of the internal equipment, the enclosure often has to be cut open and later resealed with a new weld. Welding seals can require an expensive operator and can greatly increase the maintenance, repair or refurbishing time. This can be particularly difficult when working with submerged connections and openings. A system and method for sealing any number submerged openings for a piece of submerged equipment, however, are not presently available.

### SUMMARY

In one exemplary embodiment, a system to seal any number of submerged openings for a piece of submerged equipment may be described. The system can have a pump having an uninterruptable power supply and a display, the uninterruptable power supply includes a battery back-up that provides a constant source of electrical energy; a tube connection extended from the pump, the tube connection providing a pressurized media to the system; a submerged enclosure receiving the pressurized media from the tube connection extending from the pump, the submerged enclosure includes one or more internal bellows, a submerged opening and an electronic module with a differential pressure transducer; a pressure control signal emitted from the differential pressure transducer, the pressure control signal transmitted to and displayed on the display; and an internal leak protector providing an alarm output signal to the display when the pressurized media is leaking.

In another exemplary embodiment, a method for sealing any number of submerged openings for a piece of submerged equipment may be shown and described. The method can include maintaining a positive internal pressure within a submerged enclosure enclosing the piece of submerged equipment with a pump; sensing an external pressure approaching the positive internal pressure with a differential pressure transducer; sending a pressure control signal from the differential pressure transducer to the pump to increase the positive internal pressure; increasing the positive internal pressure to exceed the external pressure with a pressurizing media; displaying the positive internal pressure and the external pressure on a display for monitoring and data collection; and providing an internal leak protector with an alarm output signal to the display when the pressurizing media from the pump is leaking.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a system to seal any number submerged openings for a piece of submerged equipment.

FIG. 2 is an exemplary diagram showing a flowchart of a method for sealing any number submerged openings for a piece of submerged equipment.

### DETAILED DESCRIPTION

Aspects of the present invention are disclosed in the following description and related figures directed to specific embodiments of the present invention. Those skilled in the art will recognize that alternate embodiments may be devised without departing from the spirit or the scope of the claims. Additionally, well-known elements of exemplary embodiments of the present invention will not be described in detail or will be omitted so as not to obscure the relevant details of the present invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the present invention”, “embodiments” or “present invention” do not require that all embodiments of the present invention include the discussed feature, advantage, or mode of operation.

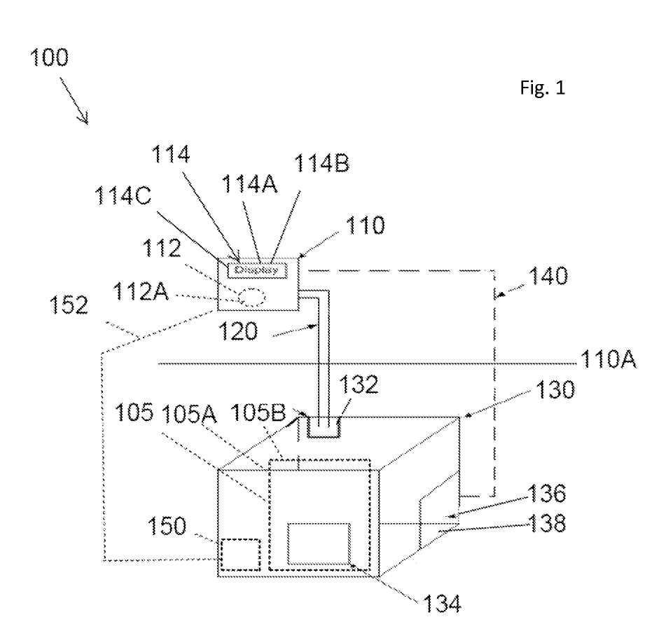

FIG. 1 is an exemplary diagram showing a system 100 which may be utilized to seal any number of submerged openings for a piece of submerged equipment 105. The piece of submerged equipment 105 may include, but is not limited to, an electric cabinet 105A or an electric box 105B, either alone or in combination with any other element.

Still referring to exemplary FIG. 1, the system 100 may include a pump 110, a tube connection 120, a submerged enclosure 130, a pressure control signal 140 and an internal leak protector 150.

The pump 110 in exemplary FIG. 1 may include a power supply, which may be any form of power supply, including an uninterruptable power supply 112, and a display 114. The uninterruptable power supply 112 may include a battery back-up 112A that can provide a constant or near-constant source of electrical energy that may be accessed twenty-four hours a day, seven days a week. The display 114 may include, but is not limited to, a digital display 114A from any number of relay contacts 114B or a wireless signal 114C, either alone or in combination with any other element. The pump 110 may be above a liquid submerging surface 110A. The tube connection 120 may extend from the pump 110 and can provide pressurized air or liquid to the system 100. The submerged enclosure 130 may receive the pressurized air or liquid from the tube connection 120 extending from the pump 110. The submerged enclosure 130 may further include any number of internal bellows 132, a submerged opening 134 and an electronic module 136 with a differential pressure transducer 138. The pressure control signal 140 may be provided by the differential pressure transducer 138 and may be displayed on the display 114. The pressure control signal 140 may include, but is not limited to, the internal pressure data of the submerged enclosure 130, external pressure data of the submerged enclosure 130, and a difference between the internal pressure data of the submerged enclosure 130 and the external pressure data of the submerged enclosure 130, either alone or in combination with any other element or data. The internal leak protector 150 may provide an alarm output signal 152 when the pressurized air or liquid is leaking to the display 114.

Further, and still referring to exemplary FIG. 1, the pump 110 can maintains a positive internal pressure within a submerged enclosure 130. If the differential pressure transducer 138 senses that the external pressure of the submerged enclosure 130 is approaching the internal pressure of the submerged enclosure 130, the electronic module 136 may send a pressure control signal to the pump 110 to increase the internal enclosure pressure of the submerged enclosure 130. As a result, a positive pressure can be maintained within the submerged enclosure 130. In some exemplary embodiments, submerged openings may be seal with any standard methods of sealing openings for mechanical and electrical connections, instead of, or in conjunction with being sealed with a weld. The pressurizing media may be either liquid or gas, as desired. The pressurizing media may be isolated from the internal medium with any number of internal bellows 132. The internal pressure may be increased or decreased by regulation in order to maintain differential pressures within design limits or within any other predetermined limits. The pressurizing equipment may be placed above the submerging media. The external and internal pressures as well as the control signals may be provided on a display 114, relay contacts 114B and/or a wireless signal (not shown). An internal leak detector may be utilized to provide an alarm output signal, as desired.

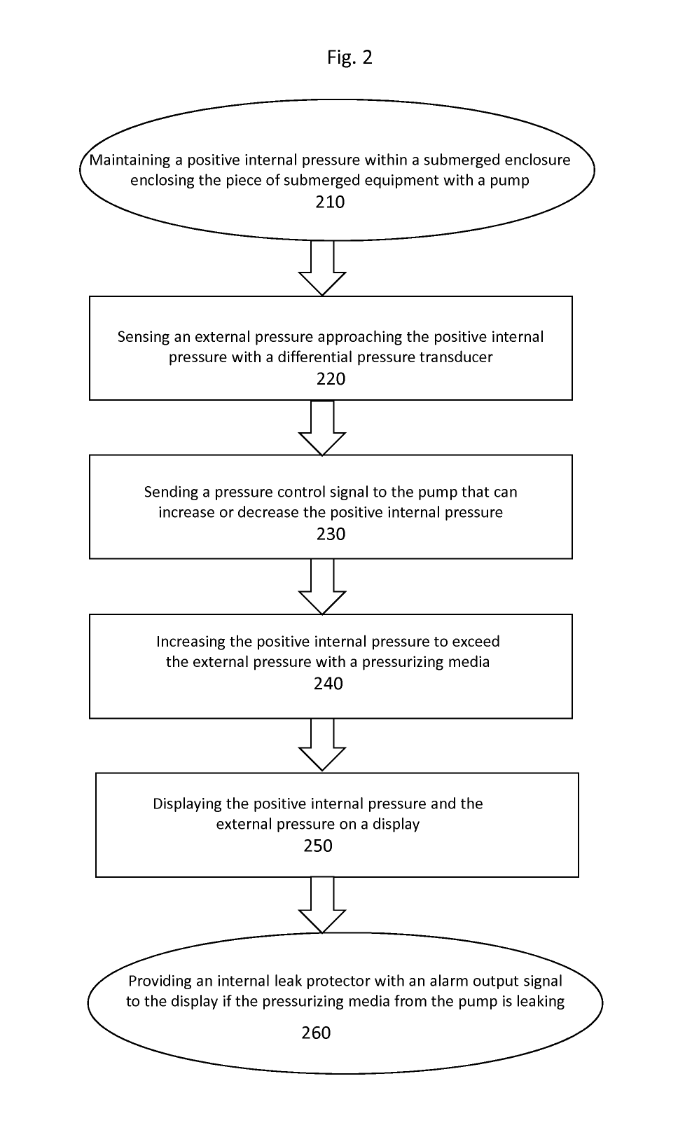

FIG. 2 is an exemplary diagram showing a flowchart of a method 200 for sealing any number submerged openings for a piece of submerged equipment.

The method for sealing any number of submerged openings for a piece of submerged equipment 200 may include a steps of maintaining a positive internal pressure within a submerged enclosure enclosing the piece of submerged equipment with a pump 210. The method can further have a step of sensing an external pressure approaching the positive internal pressure with a differential pressure transducer 220. In further embodiments, there may be a step of sending, by the differential pressure transducer, a pressure control signal to the pump that can increase or decrease the positive internal pressure 230, as desired. This may further include a step of increasing the positive internal pressure to exceed the external pressure with a pressurizing media 240. Next, there may be a step whereby a display is displaying the positive internal pressure and the external pressure on a display for monitoring and data collection 250 and providing an internal leak protector with an alarm output signal to the display if the pressurizing media from the pump is leaking 260.

The method 200 may further include a step of actively regulating the positive internal pressure within the submerged enclosure. The method 200 thus may provide a situation or environment where the positive internal pressure within the submerged enclosure prevents a submerging liquid from seeping into the piece of submerged equipment. Additionally, in an exemplary embodiment, the step of maintaining a positive internal pressure 210 may further include the positive internal pressure within the submerged enclosure eliminating decommissioning. The step of sensing an external pressure approaching the positive internal pressure 220 may further include the pressurized submerged enclosure allowing one or more standard sealing methods for one or more connections and openings without welding. Step 230 may also include placing the pump above a liquid submerging surface and supporting the pump with a battery back-up with an uninterruptable power supply. Additionally, the sending of a pressure control signal to the pump that can increase the positive internal pressure 230 may include sending or relaying additional information. For example, any data sent may also include internal pressure data of the submerged enclosure, external pressure data of the submerged enclosure, and a difference between the internal pressure data of the submerged enclosure and the external pressure data of the submerged enclosure.

In still further exemplary embodiments of FIG. 2, the step of increasing the positive internal pressure 240 may also include maintain the pressurizing media with a liquid pressurizing media or a gas pressurizing media. The displaying step 250 may additionally include the display displaying the positive internal pressure and the external pressure for monitoring and data collection. Further, the step of providing an internal leak protector 260 may include providing an internal leak protector with an alarm output signal to a display when the pressurizing media from the pump is leaking.

As shown in these exemplary embodiments, several benefits of the system and method for sealing submerged openings for a piece of submerged equipment become apparent. For example, a submerged electrical box may not require expensive welding joints for sealing but instead may utilize other standard methods of sealing openings for mechanical and electrical connections. The utilization of standard sealing methods may not rely on an expensive, trained operator for welding seals. The utilization of standard sealing methods may further eliminate decommissioning and the pressure tests that take place after the placement of new welded seals. The utilization of standard sealing methods therefore may greatly reduce the cost and time for regular maintenance, repair and refurbishing of equipment.

The foregoing description and accompanying figures illustrate the principles, embodiments and modes of operation of the present invention. However, the present invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the present invention as defined by the following claims.

What is claimed is:

1. A system to seal one or more submerged openings for a piece of submerged equipment, comprising:
a pump having a power supply and a display, the uninterruptable power supply includes a battery back-up that provides a constant source of electrical energy;
a tube connection extended from the pump, the tube connection providing a pressurized media to the system;
a submerged enclosure receiving the pressurized media from the tube connection extending from the pump, the submerged enclosure includes one or more internal bellows, a submerged opening and an electronic module with a differential pressure transducer;
a pressure control signal emitted from the differential pressure transducer, the pressure control signal transmitted to and displayed on the display; and
an internal leak protector providing an alarm output signal to the display when the pressurized media is leaking.

2. The system according to claim 1, wherein the piece of submerged equipment is an electric cabinet.

3. The system according to claim 1, wherein the piece of submerged equipment is an electric box.

4. The system according to claim 1, wherein the pump is disposed above a liquid submerging surface.

5. The system according to claim 1, wherein the display is a digital display.

6. The system according to claim 1, wherein the display is from one or more relay contacts.

7. The system according to claim 1, wherein the display is from a wireless signal.

8. The system according to claim 1, wherein the pressurized media is one of a pressurized gas media and a pressurized liquid media.

9. The system according to claim 1, wherein the power supply is an uninterruptable power supply.

10. The system according to claim 1, wherein the pressure control signal comprises internal pressure data of the submerged enclosure, external pressure data of the submerged enclosure, and the difference between the internal pressure of the submerged enclosure and the external pressure of the submerged enclosure.

11. A method for sealing one or more submerged openings for a piece of submerged equipment, comprising:
maintaining a positive internal pressure within a submerged enclosure enclosing the piece of submerged equipment with a pump;
sensing an external pressure approaching the positive internal pressure with a differential pressure transducer;
sending a pressure control signal from the differential pressure transducer to the pump to increase or decrease the positive internal pressure;
increasing the positive internal pressure to exceed the external pressure with a pressurizing media;
displaying the positive internal pressure and the external pressure on a display for monitoring and data collection; and
providing an internal leak protector with an alarm output signal to the display when the pressurizing media from the pump is leaking.

12. The method according to claim 11, further comprising:
actively regulating the positive internal pressure within the submerged enclosure.

13. The method according to claim 11, further comprising:
preventing a submerging liquid from seeping into the piece of submerged equipment within the submerged enclosure prevents with a positive internal pressure.

14. The method according to claim 11, wherein the pressurized submerged enclosure allows one or more standard sealing methods for one or more connections and openings without welding.

15. The method according to claim 11, further comprising:
eliminating decommissioning with the positive internal pressure within the submerged enclosure.

16. The method according to claim 11, further comprising:
placing the pump above a liquid submerging surface and supporting the pump with a battery back-up.

17. The method according to claim 11, wherein the pressure control signal includes internal pressure data of the submerged enclosure, external pressure data of the submerged enclosure, and the difference between the internal pressure of the submerged enclosure and the external pressure of the submerged enclosure.

18. The method according to claim 11, wherein the pressurizing media is a liquid pressurizing media.

19. The method according to claim 11, wherein the pressurizing media is a gas pressurizing media.

20. The method according to claim 11, further comprising:
containing the pressurizing media in one or more bellows inside the submerged enclosure.
